(19) United States
(12) Patent Application Publication
(10) Pub. No.: US 2005/0161577 A1
(43) Pub. Date: Jul. 28, 2005

(54) Mounting system for electric motor

(75) Inventor: Michael M. French, O'Fallon, MO (US)

Correspondence Address: SENNIGER POWERS LEAVITT AND ROEDEL, ONE METROPOLITAN SQUARE, 16TH FLOOR, ST LOUIS, MO, 63102, US

(73) Assignee: Emerson Electric Co.

(21) Appl. No.: 10/828,673

(22) Filed: Apr. 21, 2004

Related U.S. Application Data
(60) Provisional application No. 60/538,843, filed on Jan. 23, 2004.

(51) Int. Cl. H02K 11/00

(52) U.S. Cl. 248/672

(57) ABSTRACT

A system and method for fastening a dynamoelectric machine, such as an electric motor having stamped steel ends, to a mount. The system includes at least one hole on a mounting end of the motor, and a fastener insert received in the hole. The insert is secured by a deformation on the insert which clamps the mounting end. The insert has a bore with pre-formed internal threads suitable for receiving a threaded fastener. The mount includes a recess and a slot for receiving the fastener such that the mount and motor are relatively rotatable for mounting.

### CROSS-REFERENCE TO RELATED APPLICATION

This application claims the benefit of U.S. Provisional Application No. 60/538,843, filed Jan. 23, 2004.

### BACKGROUND OF THE INVENTION

This invention relates generally to dynamoelectric machines, and in particular to a mounting system for connecting an electric motor to an adjacent part, such as a grill of an air conditioner condensing unit.

Dynamoelectric machines, such as electric motors used in appliances, are frequently held in place by mounting systems located at ends of the motors. For example, an outdoor condensing unit of an air conditioner has an electric motor which drives a fan to propel air through the unit, and thereby enhance heat transfer. Air is typically drawn into the unit through a side and expelled vertically upward through a grill forming part of an upper cover. The electric motor is positioned directly beneath the grill. It is mounted in a vertical orientation with an upper end of the motor fastened to the grill and its output fan drive shaft extending vertically downward.

Various systems have been used for mounting the upper end of a motor to a grill. One system includes four bolt fasteners at spaced positions around the end of the motor, with heads of the fasteners being pressed into the end and shanks (or studs) protruding vertically upward. The fasteners are received through corresponding holes on the grill, and conventional nuts are installed to tighten the attachment. Unfortunately, that system results in the studs protruding above the nuts and the grill. The studs are frequently covered by a plastic sleeve, but even when covered they pose a safety hazard.

Another mounting system features a “screw-in” arrangement where self-tapping fasteners are threaded downward into the upper end of the motor, leaving heads of the fasteners positioned on top and generally flush with the grill. Because the upper end of the motor is generally thin in construction, thick bosses have been cast into the end to accommodate bores for receiving the fasteners. Each bore must have adequate depth for secure thread engagement to tighten the fastener and withstand exposure to vibrations over an extended duration. The bosses add material to the end of the motor and therefore increase cost. Further, some motors require a process of self-tapping with thread-forming screws, which is time consuming and increases likelihood of error. It also precludes use of conventional machine screws, which have lower cost than thread-forming screws. The “screw-in” mount has been unavailable with motors which have ends formed of stamped steel, such as two-piece “clamshell” housing type motors, which would provide lower cost.

### SUMMARY OF THE INVENTION

Among the several objects and features of the present invention may be noted the provision of a system and method which attach a dynamoelectric machine to a mount; the provision of such a system and method usable with machines having stamped steel ends; the provision of such a system and method which produce a strong and durable attachment; the provision of such a system and method which facilitate attachment without need for specialized tooling or fasteners; the provision of such a system and method which avoid stripping of threads; and the provision of such a system and method which are economical.

In general, a system according to the present invention fastens a dynamoelectric machine to a mount. The system comprises a dynamoelectric machine having two opposite ends, one of the ends comprising a mounting end having at least one fastener hole extending therethrough. A fastener insert is secured in each fastener hole on the mounting end, the fastener insert having a bore with pre-formed internal threads for receiving a threaded fastener to fasten the dynamoelectric machine to the mount.

In another aspect, a method of the present invention connects a dynamoelectric machine to an adjacent mount during an assembly procedure. The dynamoelectric machine has opposite longitudinal ends. The method comprises the steps of forming two or more fastener holes in one of the longitudinal ends of the dynamoelectric machine, and inserting a fastener insert in each of the fastener holes. Each fastener insert has a tubular configuration with pre-formed internal threads and an external surface sized and shaped for being received in the corresponding fastener hole. Each fastener insert is secured in the corresponding fastener hole. The dynamoelectric machine is placed at a position adjacent to the mount for assembly therewith. A threaded fastener is inserted through the mount into the fastener insert. The fastener is threaded into engagement with the pre-formed internal threads of the fastener insert.

Other objects and features of the present invention will be in part apparent and in part pointed out hereinafter.

### BRIEF DESCRIPTION OF THE DRAWINGS

FIG. 1 is a perspective of an electric motor with a mounting system according to the present invention;

FIGS. 2A and 2B are top perspectives of an end of the motor with fastener inserts having circular and hexagonal shapes, respectively;

FIG. 3 is a bottom perspective of the end of FIG. 2A;

FIG. 4 is an elevation of the end of FIGS. 2A and 3;

FIG. 5 is a fragmentary section of the endshield taken along line 5-5 of FIG. 4;

FIG. 6 is an exploded perspective of a grill of an air conditioner condenser unit for mounting to the motor;

FIG. 7 is an enlarged, fragmentary plan of the grill;

FIG. 8 is a section taken along line 8-8 of FIG. 7;

FIG. 9 is a section taken along line 9-9 of FIG. 7; and

FIG. 10 is a view similar to FIG. 7 of a grill of a second embodiment.

Corresponding reference characters indicate corresponding parts throughout the views of the drawings.

### DETAILED DESCRIPTION OF THE PREFERRED EMBODIMENT

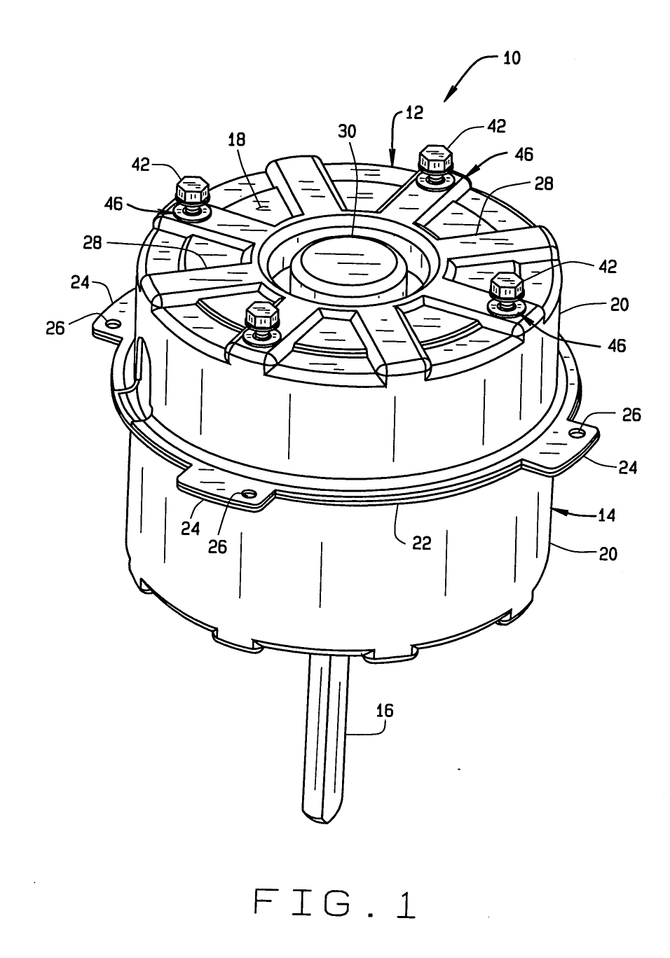

Referring now to the drawings and in particular to FIG. 1, a dynamoelectric machine having a mounting system according to the present invention is indicated generally at 10. In one embodiment, the machine 10 is an electric motor for installation in an outdoor condensing unit of an air conditioner to drive a fan (not shown) of the condensing unit. Although the description herein is primarily with reference to that embodiment, it is understood that other dynamoelectric machines, such as generators or motors for other fields of use do not depart from the scope of this invention.

The motor 10 illustrated in FIG. 1 is a two-piece, or “clamshell” type motor having two attached housing members 12, 14 which enclose a conventional stationary assembly or stator (not shown) and a rotatable assembly or rotor (not shown). As is known in the art, the stator is generally annular and holds one or more wire-wound coils, or windings. When energized with electrical current, the windings interact with the rotor to produce torque. The rotor is coupled to an elongate shaft 16 (FIG. 1) which extends from the housing for transmitting power to the fan. For this embodiment, the motor 10 is oriented in the condenser unit with the shaft 16 extending vertically downward, with the two housing members thereby being positioned in vertical relation (hereinafter “upper end” 12 and “lower end” 14 of the motor). Each of the upper and lower ends includes an end wall 18 and a cylindric outer wall 20. Circumferential flanges 22 on the respective outer walls 20 abut each other, with tabs 24 extending from the flanges having holes 26 for connecting the upper end 12 and lower end 14 by a suitable method (e.g., swaging). The number of tabs 24 and/or holes 26 may vary. Each end wall 18 has elevated ribs 28 for strength, arranged in a radial pattern, and a center hub 30 which defines a hollow cavity for receiving a ball bearing (not shown). It is understood that other types of housings and orientations do not depart from the scope of this invention.

Preferably, each of the upper and lower ends 12, 14 is of one-piece construction and manufactured by a stamping process. The clamshell type motor 10 with stamped ends provides lower cost than a comparable motor (not shown) having three pieces including a cental cylindric casing and two die cast ends. Further, the ends 12, 14 are made of a suitable strong and rigid material (e.g., steel), which provides good strength and rigidity.

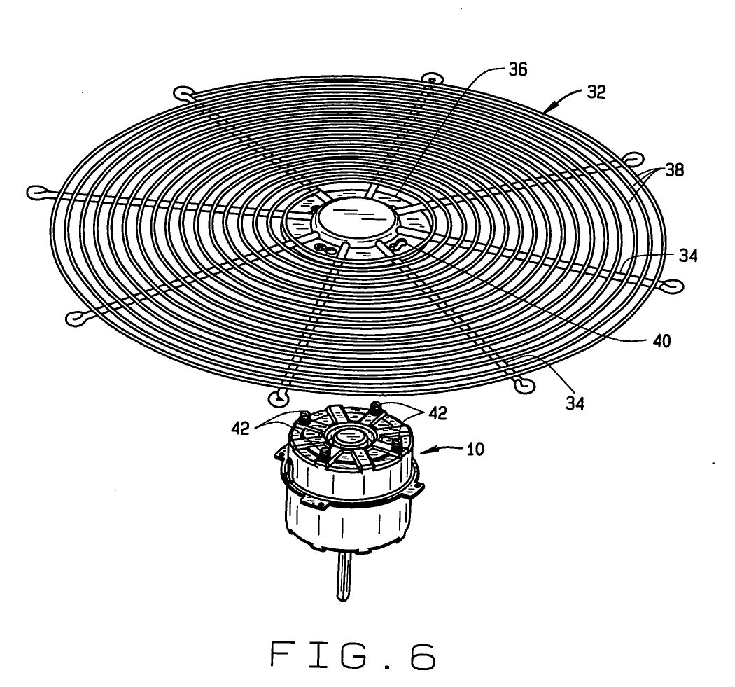

Referring to FIG. 6, the motor 10 in one embodiment is for positioning beneath a grill 32 of the outdoor condensing unit. The grill 32 shown in the drawings is of a wire construction comprising a series of wire spokes 34 radiating from a central hub 36 and supporting a spiraled wire defining a series of rings 38. However, it will be understood that the grill may have other constructions, such as a series of louvers. Typically the grill 32 is horizontal and forms part of an upper cover of the condensing unit. The central hub 36 of the grill has a solid, flat annular portion with holes 40 for receiving fasteners 42. The motor 10 is mounted in a vertical orientation with the upper end 12 of the motor attached to the grill 32. Accordingly, the upper end 12 of the motor comprises its mounting end, and the grill 32 comprises a mount from which the motor is suspended. It is understood that other portions of a motor may be attached to an adjacent part other than a grill without departing from the scope of this invention.

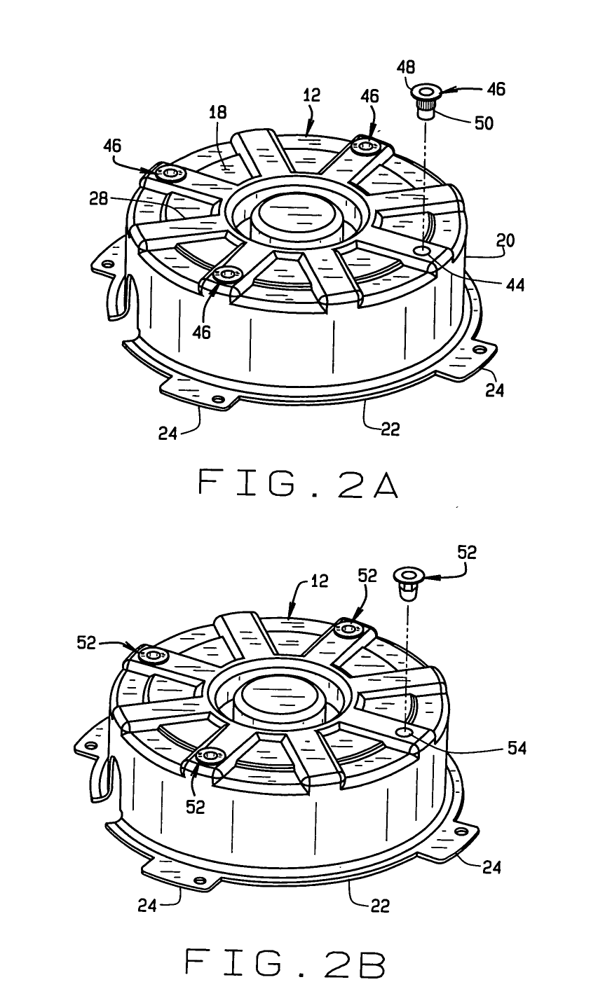

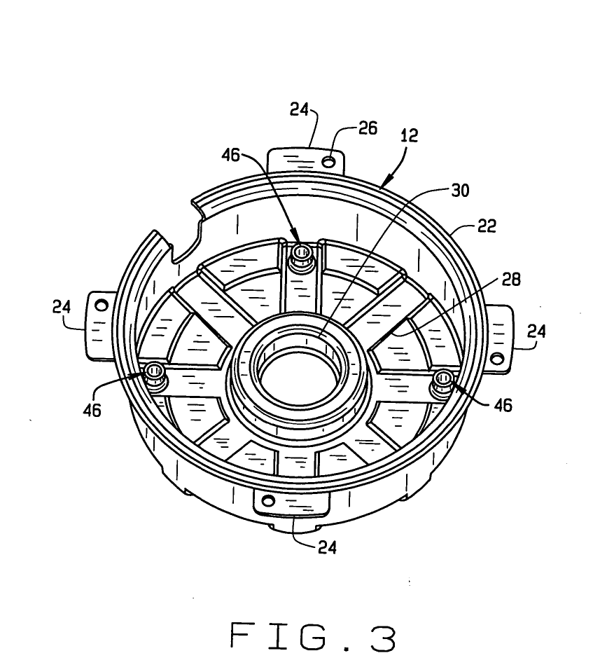

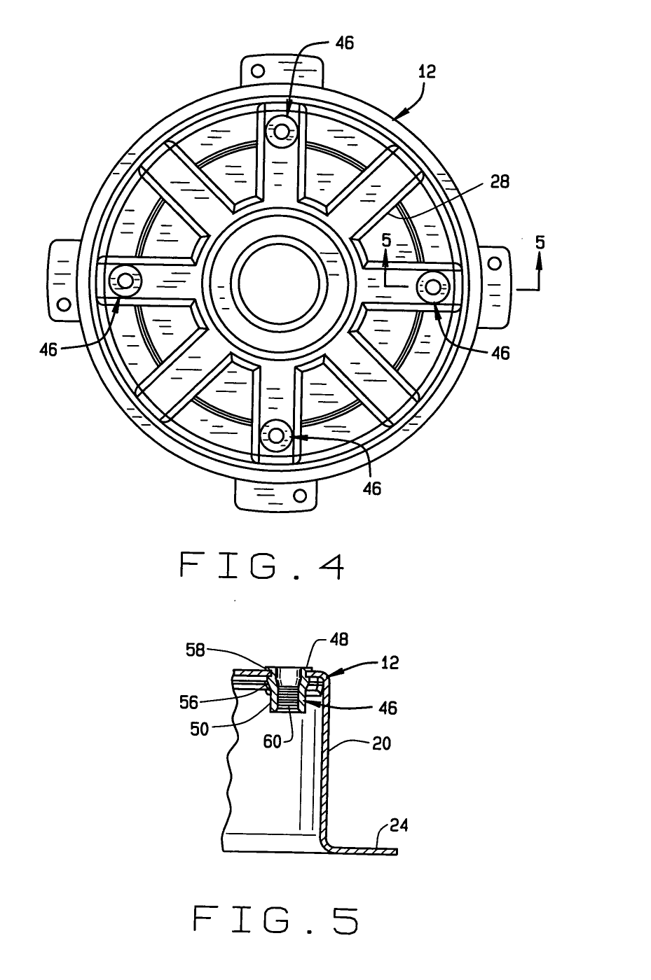

The upper end 12 of the motor has a number of holes 44 (e.g., four holes) extending through the end for receiving corresponding fastener inserts 46 (FIG. 2A) which in turn receive corresponding threaded fasteners 42. The holes 44 are at spaced positions in a circular pattern around the end 12, and are each sized and shaped to correspond with an insert 46. The inserts 46 provide a depth of material well beyond the thickness of the end 12 (FIG. 5) to provide for secure thread engagement by fasteners (e.g., screws 42) which fasten the motor 10 to the grill 32, and maintain tight engagement even when exposed to vibrations over an extended time. Preferably, each insert 46 is a self-clinching threaded rivet product having a tubular metallic body with a low-profile head 48. The insert is readily installed to a position with the head 48 engaging an outer surface of the upper end 12 of the motor.

As shown in FIG. 2A, the insert 46 has a shank 50 which is circular in cross-section and partially knurled, with each hole 44 in the mounting end 12 having a corresponding circular shape. In an alternate embodiment, shown in FIG. 2B, the insert 52 and hole 54 have corresponding polygonal shapes (e.g., hexagonal). An advantage of this embodiment relative to the configuration of FIG. 2A is increased effectiveness in resisting torque loads and avoiding rotation of the insert relative to the end of the motor.

An exemplary type of fastener insert is the Atlas Engineering SPINTITE series self-clinching threaded rivet manufactured by the PennEngineering & Manufacturing Corporation of Danboro, Pa.

Each fastener insert 46 is secured in a corresponding hole 44 by a deformation 56 on the insert which clamps the mounting end 12 of the motor between the deformation and the head 48 of the insert. As shown in FIG. 5, the deformation 56 comprises a crimped portion of the insert. A conventional installation tool (not shown) is used to attach the inserts 46. The tool presses the shank 50 of the insert axially causing material of the insert to cold flow and deform around the mounting end 12 of the motor. The deformation 56 of the shank is spaced from the head 48 and defines a gap 58 which receives a peripheral edge margin of the hole 44. Each insert 46 has a bore with pre-formed internal threads 60 suitable for receiving a threaded fastener 42 to fasten the machine to the mount. It is understood that there may be a different number or arrangement of holes and corresponding fastener inserts, including one hole and insert, without departing from the scope of this invention.

Significantly, the inserts 46 have pre-formed internal threads 60. This arrangement avoids the need to tap the inserts, which would take time and expose the insert to substantial torque loads that could weaken or break the crimped connection between the insert and the end of the motor. Moreover, the pre-formed threads 60 permit use of conventional machine screws, which are less expensive than thread-forming screws. Further, there is less opportunity for cross-threading, or stripping, of threads.

Thus, the invention permits use of a “screw-in” mounting system with lower-cost clamshell motors having stamped steel ends. The screws 42 are tightened downward into the inserts 46, leaving heads of the screws at the surface of the grill 32 or generally flush with the grill, avoiding the safety hazard and poor aesthetic appearance of protruding studs. The system can be added to pre-existing grills.

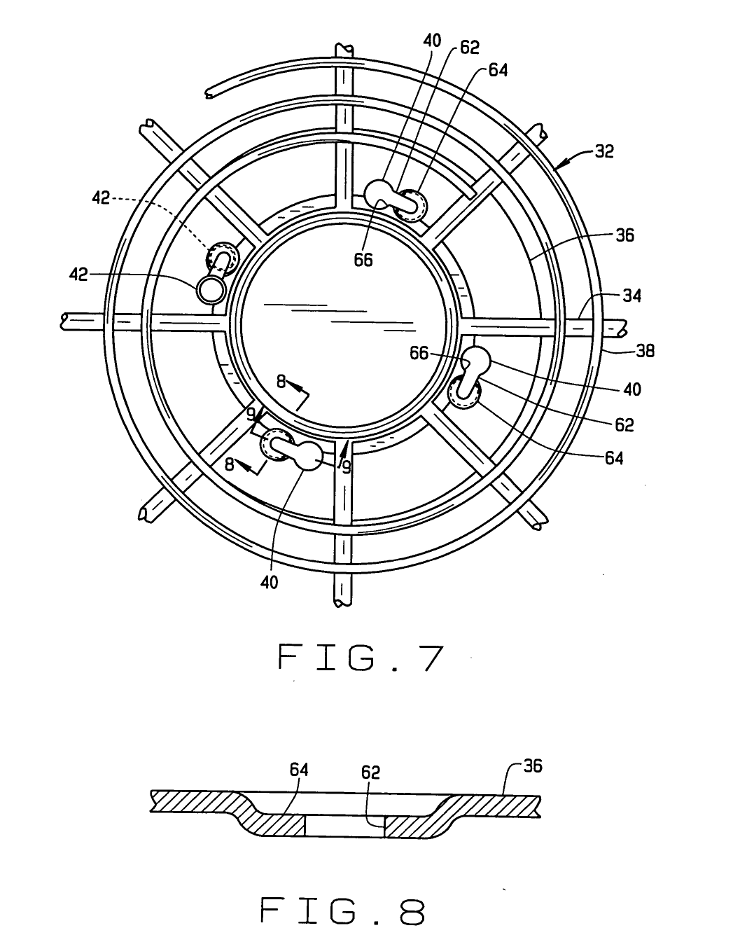

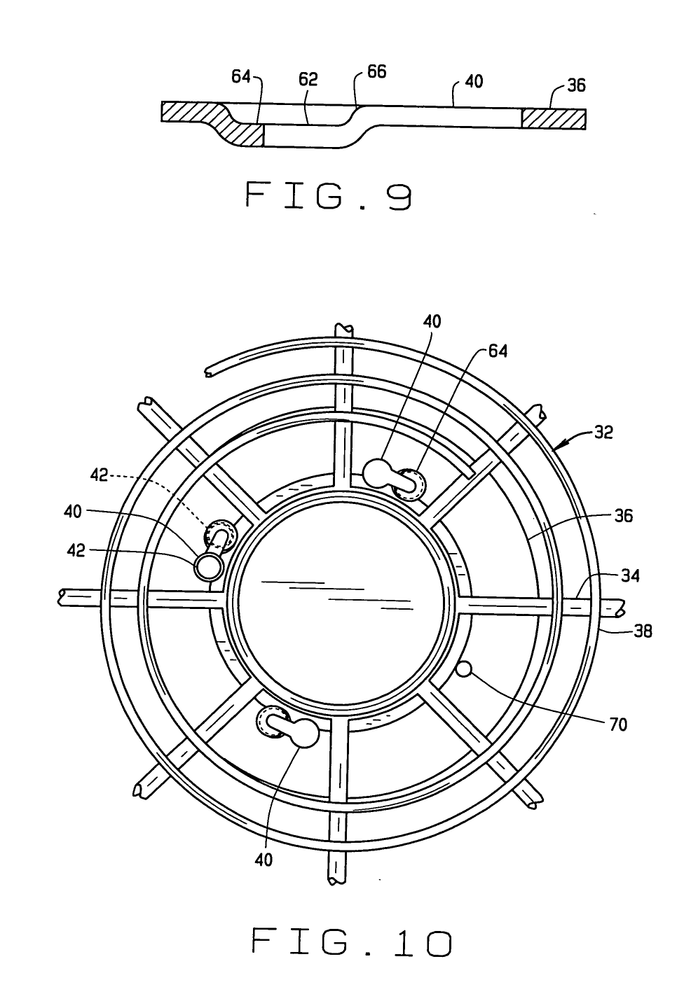

Although the system as hereinbefore described requires that the mount (i.e., the grill central hub) have only simple holes for receiving the fasteners 42, another feature of the invention is a slot 62 extending from each hole 40 for facilitating a twist-lock attachment of the grill 32 to the motor 10. As shown in FIGS. 7-9, each slot 62 extends from a hole 40 to a corresponding recess 64. The slot 62 is a straight segment generally along a tangent to a circle concentric with the center of the grill 32. Each recess 64 is defined by a region of the central hub 36 having a depressed surface relative to the surrounding surface of the hub. The recess 64 is spaced from the hole 40 and has a similar circular shape as the hole, defining a ridge 66 between the recess and hole.

For mounting the motor to the grill, the screws 42 (which are loosely received in the inserts 46) are aligned with the holes 40. The motor 10 and grill 32 are mated together so that the screws 42 are inserted to a first position (indicated by one of the screws 42 being shown in solid on FIG. 7) where the screws are received in the holes 40. The grill or motor are then rotated relative to each other to a second position (indicated by one of the screws 42 shown in phantom on FIG. 7) whereby the screws slide along the slots 62 and are received in respective recesses 64. The screws 42 are then at a fastening position, and are tightened in the inserts 46 so that the heads firmly engage the surface of the recesses 64. The screw heads are thus also recessed and therefore more nearly flush with the top of the grill 32. Inadvertent reverse rotation of the grill or motor back to the first position is prevented not only by the grip of the heads of screws 42 on the surface of the recesses 64, but also by the ridges 66 which are elevated relative to the recesses and prevent the screw heads from sliding back toward the holes 40.

Thus, the motor 10 is mounted without special tooling. Because the motor is provided with screws 42 received in the inserts 46, it is only necessary to twist the motor and then lock it at the second position by tightening the screws. There is no opportunity for cross-threading, or stripping, of threads because the screws are already aligned and received in the inserts prior to the twist and lock mounting.

An alternate embodiment is shown in FIG. 10. Instead of four holes 40 and corresponding slots 62 for receiving screw heads, the central hub 36 of the grill includes three holes and slots. A smaller hole 70 is also provided for receiving a locking pin (not shown) to extend into the upper end 12 of the motor and further prevent inadvertent relative rotation between the grill 32 and motor 10. It is understood that a different number, configuration, or arrangement of slots or holes does not depart from the scope of this invention.

In view of the above, it will be seen that the several objects of the invention are achieved and other advantageous results obtained.

When introducing elements of the present invention or the preferred embodiment(s) thereof, the articles “a”, “an”, “the” and “said” are intended to mean that there are one or more of the elements. The terms “comprising”, “including” and “having” are intended to be inclusive and mean that there may be additional elements other than the listed elements.

As various changes could be made in the above without departing from the scope of the invention, it is intended that all matter contained in the above description and shown in the accompanying drawings shall be interpreted as illustrative and not in a limiting sense.

1. A system for fastening a dynamoelectric machine to a mount, the system comprising:
a dynamoelectric machine having two opposite ends, one of said ends comprising a mounting end having at least one fastener hole extending therethrough; and
a fastener insert secured in each said at least one fastener hole on said mounting end, the fastener insert having a bore with pre-formed internal threads for receiving a threaded fastener to fasten the dynamoelectric machine to said mount.

2. A system as set forth in claim 1 wherein said fastener insert comprises a head, a shank extending from the head, and a deformation on the shank spaced from the head to define a gap receiving a peripheral edge margin of said at least one fastener hole.

3. A system as set forth in claim 2 wherein the deformation on the shank of the insert comprises a portion of the shank crimped against the peripheral edge margin of said at least one fastener hole.

4. A system as set forth in claim 3 wherein the mounting end of the dynamoelectric machine has an inner surface and an outer surface, and wherein the head of the fastener insert contacts the outer surface of the dynamoelectric machine.

5. A system as set forth in claim 1 wherein said dynamoelectric machine includes a motor housing comprising two attached members.

6. A system as set forth in claim 5 wherein each member of the motor housing is formed of stamped steel.

7. A system as set forth in claim 1 wherein said fastener hole in the mounting end and said fastener insert have corresponding circular shapes.

8. A system as set forth in claim 1 wherein said hole in the mounting end and said fastener insert have corresponding polygonal shapes.

9. A system as set forth in claim 1 wherein there are four fastener holes in the mounting end and four corresponding fastener inserts.

10. A system as set forth in claim 1 further comprising said threaded fastener, the fastener comprising a machine screw having a shank and a head.

11. A system as set forth in claim 10 further comprising said mount, the mount comprising a portion of a grill having a hole for receiving the fastener.

12. A system as set forth in claim 11 wherein said mount includes a recess for receiving the head of the fastener and a slot extending from the hole to the recess.

13. A system as set forth in claim 12 wherein the mount has a center and the slot extends in a direction generally along a tangent to a circle concentric with the center.

14. A system as set forth in claim 13 wherein the mount and machine are relatively rotatable between a first position wherein said fastener is received in said hole and a second position wherein said fastener is received in said recess.

15. A method of connecting a dynamoelectric machine to an adjacent mount during an assembly procedure, the dynamoelectric machine having opposite longitudinal ends, the method comprising the steps of:
forming two or more fastener holes in one of said longitudinal ends of the dynamoelectric machine;
inserting a fastener insert in each of said fastener holes, each fastener insert having a tubular configuration with pre-formed internal threads and an external surface sized and shaped for being received in the corresponding fastener hole;
securing each fastener insert in the corresponding fastener hole;
placing the dynamoelectric machine at a position adjacent to said mount for assembly therewith;
inserting a threaded fastener through said mount into said fastener insert; and
threading the fastener into engagement with said pre-formed internal threads of said fastener insert.

16. A method as set forth in claim 15 wherein the step of securing each fastener insert comprises crimping each fastener insert against said end of the machine.

17. A method as set forth in claim 15 wherein said step of inserting a threaded fastener through said mount further comprises effecting relative rotation between the machine and the mount.

18. A method as set forth in claim 17 wherein said rotation causes said fastener to be slidably moved along a slot in the mount to a fastening position.
